(19) United States
(12) Patent Application Publication
(10) Pub. No.: US 2019/0225022 A1
(43) Pub. Date: Jul. 25, 2019

(54) PNEUMATIC TIRE

(71) Applicant: TOYO TIRE & RUBBER CO., LTD., Itami-shi, Hyogo (JP)

(72) Inventor: Sachio Sakamoto, Itami-shi (JP)

(73) Assignee: TOYO TIRE & RUBBER CO., LTD., Itami-shi, Hyogo (JP)

(21) Appl. No.: 16/233,320

(22) Filed: Dec. 27, 2018

(30) Foreign Application Priority Data
Jan. 22, 2018 (JP) 2018-008057

(51) Int. Cl. B60C 11/00; B60C 11/03

(52) U.S. Cl. CPC B60C 11/0083; B60C 2011/0341; B60C 11/033; B60C 11/0316

(57) ABSTRACT

A pneumatic tire has a plurality of main grooves extending in a tire circumferential direction, and a plurality of land lines defined by the plurality of main grooves in a tread face. At least one of the plurality of land lines extends outward in a tire diametrical direction from a tread profile. A plurality of lateral grooves or notches are formed at intervals in the tire circumferential direction in the at least one land line. Each of blocks formed between the lateral grooves or the notches has a protruding height from the tread profile that increases from circumferential opposite end portions toward a circumferential central portion of the block.

### BACKGROUND OF THE INVENTION

### Field of the Invention

The present invention relates to a pneumatic re with a land line protruding outward in a tire diametrical direction from a tread profile.

### Description of the Relate Art

Normally, a plurality of land lines are provided on a tread face of a pneumatic tire and top faces of the respective land lines are aligned with a tread profile forming an arc shape in a section along a tire meridian. On the other hand, as described in Patent Documents 1 and 2, there are known pneumatic tires each of which has land lines protruding outward in a tire diametrical direction from a tread profile. Such a tread configuration is intended for improvement of a contact property of a tread face and more concrete for increase of irregular wear resistance and braking performance by uniformizing contact pressure in the tread face.

In order to improve the contact property of the tread face, it is preferable to enhance the contact property of each of the land lines. However, when the land line is formed as a block line including a plurality of blocks arranged in a tire circumferential direction, it has been found that there is room for improvement of the contact property of the land line. This is because a central portion of each of the blocks in the circumferential direction has high rigidity and a relatively low stretch degree as compared to opposite end portions of the block in the circumferential direction facing lateral grooves or notches and therefore has a lower contact pressure than that of the opposite end portions in the circumferential direction.

### PRIOR ART DOCUMENTS

### Patent Documents

Patent Document 1: JP-A-2017-030635

Patent Document 2: JP-A-2015-182680

### SUMMARY OF THE INVENTION

The present invention has been made with the above-described circumstances in view and its object is to provide a pneumatic tire with enhanced contact property of land line.

The present invention provides a pneumatic tire comprising a tread face, a plurality of main grooves extending in a tire circumferential direction in the tread face, and a plurality of land lines defined by the plurality of main grooves in the tread face, wherein at least one of the plurality of land lines extends outward in a tire diametrical direction from a tread profile, a plurality of lateral grooves or notches are formed at intervals in the tire circumferential direction in the at least one land line, and each of blocks formed between the lateral grooves or the notches has a protruding height from the tread profile that increases from circumferential opposite end portions toward a circumferential central portion of the block. In this way, it is possible to help the circumferential central portions of the blocks come in contact with the ground to thereby enhance a contact property of the land line.

It is preferable that a top face of each of the blocks is formed in an arc shape protruding outward in the tire diametrical direction in a section parallel to a tire equatorial plane. In this way, it is possible to effectively enhance the contact property of the land line.

In the section parallel to the tire equatorial plane, a radius of curvature of an arc forming a top face of each of the blocks having a relatively large length in the tire circumferential direction may be larger than a radius of curvature of an arc forming a top face of each of the blocks having a relatively small length in the tire circumferential direction. In this way, the top face of each of the blocks is formed in the arc shape having the curvature suitable for the length of the block in the tire circumferential direction, which enhances the contact property of each of the land lines.

It is preferable that a void ratio of a first area positioned on one side of a center of each of the blocks in the tire circumferential direction is smaller than a void ratio of a second area positioned on the other side and a protruding height of the first area is larger than a protruding height of the second area. In this way, it is possible to help the first area with the relatively low void ratio come in contact with the ground to thereby enhance the contact property of the land line.

It is preferable that a void ratio of a third area positioned on one side of a center of each of the blocks in the tire width direction is smaller than a void ratio of a fourth area positioned on the other side and a protruding height of the third area is larger than a protruding height of the fourth area. In this way, it is possible to help the third area with the relatively low void ratio come in contact with the ground to thereby enhance the contact property of the land line.

### BRIEF DESCRIPTION OF THE DRAWINGS

FIG. 1 is a schematic sectional view along a tire meridian of an example of a pneumatic tire according to the present invention;

FIG. 2 is a developed view of a tread face;

FIG. 3 is a sectional view along the tire meridian of a center land line;

FIG. 4 is a sectional view taken along line A-A in FIG. 3;

FIG. 5 is a side view of a block forming the center land line;

FIG. 6 is a perspective view of a block forming the center land line;

FIGS. 7(a) and 7(b) are a sectional view along the tire meridian and a sectional view taken along line B-B, respectively, of a block forming a mediate land line;

FIG. 8 is a plan view of a block forming a center land line according to another embodiment of the invention;

FIG. 9 is a plan view of a block forming a center land line according to another embodiment of the invention;

FIG. 10 is a sectional view (a sectional view taken along line C-C in FIG. 11) of the block in FIG. 9 and parallel to a tire equatorial plane; and

FIG. 11 is a sectional view along a tire meridian of the block in FIG. 9.

### DETAILED DESCRIPTION OF THE PREFERRED EMBODIMENTS

Embodiments of the present invention will be described below with reference to the drawings.

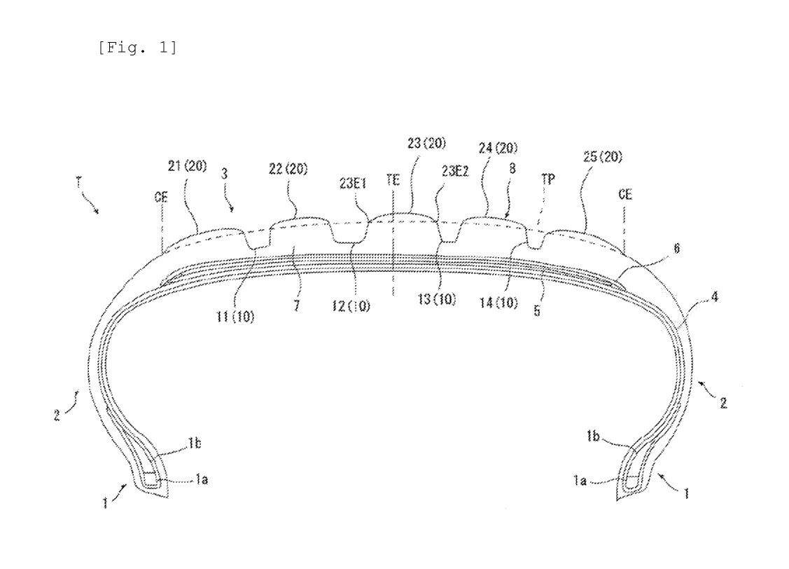

As shown in. FIG. 1, a pneumatic tire T includes paired bead portions 1, 1, paired sidewall portions 2, 2 respectively extending outward in a tire diametrical direction from the bead portions 1, and a tread portion 3 connected to outer ends the tire diametrical direction of the respective sidewall portions 2. A carcass layer 4 is provided in a toroidal shape between the paired bead portions 1, 1. Each of end portions of the carcass layer 4 is rolled up to wrap a bead core 1a and a bead filler 1b embedded in the bead portion 1.

On an outer side of the carcass layer 4 in the tire diametrical direction, a belt layer 5, a belt reinforcing layer 6, and a tread rubber 7 are provided. The belt layer 5 includes a plurality of belt plies. The respective belt plies are formed by covering cords, extending obliquely with respect to a tire circumferential direction, with rubber. The belt plies are layered so that the cords cross each other in opposite orientations to each other in the respective plies. The belt reinforcing layer 6 is formed by covering cords, extending substantially in the tire circumferential direction, with rubber. A tread face 8 that forms an outer peripheral face of the tread rubber 7 is provided with a tread pattern.

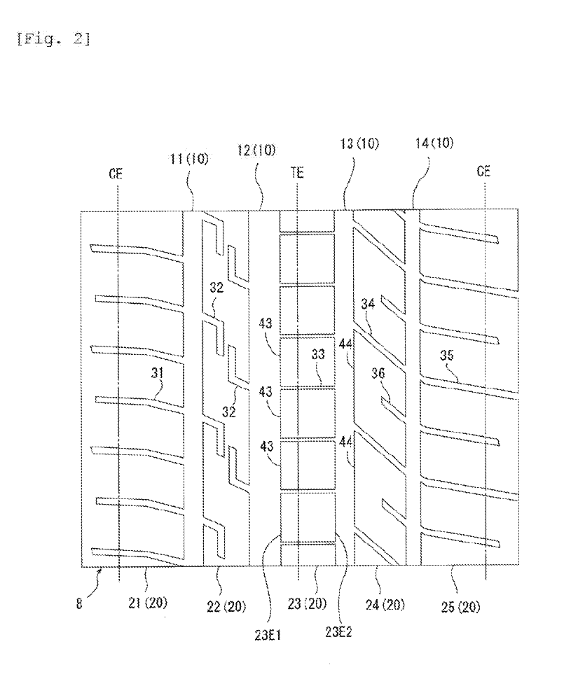

As shown in FIGS. 1 and 2, the tread face 8 is provided with a plurality of main grooves 10 extending in the tire circumferential direction and a plurality of land lines 20 defined by the plurality of main grooves 10. Preferably, three or mere main grooves 10 are provided. In the embodiment, four main grooves 10 are provided in the tread face 8 and five land lines 20 are defined by the four main grooves 10.

The four main grooves 10 include paired center main grooves 12, 13 positioned on left and right opposite sides of a tire equatorial plane TE and paired shoulder main grooves 11, 14 positioned on outer sides of the center main grooves 12, 13 in a tire width direction. The paired shoulder main grooves 11, 14 are positioned on outermost sides in the tire width direction among the plurality of main grooves 10. Although all of the four main grooves 10 are straight grooves, part or all of the main grooves 10 may be zigzag grooves. The five land lines 20 include a center land line 23 passing through the tire equatorial plane TE, paired mediate land lines 22, 24 positioned on outer sides of the center land line 23 in the tire width direction, and paired shoulder land lines 21, 25 positioned on the outer sides of the mediate land lines 22, 24 in the tire width direction.

The center land line 23 is provided between the paired center main grooves 12, 13. The mediate land line 22 is provided between the shoulder main groove 11 and the center main groove 12 and the mediate land line 24 is provided between the center main groove 13 and the shoulder main groove 14. The shoulder land line 21 is provided between the shoulder main groove 11 and a contact end CE and the shoulder land line 25 is provided between the shoulder main groove 14 and a contact end CE. The contact ends CE refer to outermost positions in the tire width direction of a contact face that comes in contact with a flat road surface when the tire mounted to a normal rim and inflated to normal internal pressure is placed vertically on the road surface and a normal load is applied to the tire.

The normal rim refers to a rim specified for each tire by standards in a standard system including the standards according to which tires are provided, and is “Standard Rim” in JATMA, “Design Rim” in TRA, or “Measuring Rim” in ETRTO, for example. The normal internal pressure refers to an air pressure specified for each tire by the standards in the standard system including the standards according to which tires are provided, and is “Maximum Air Pressure” in JATMA, a maximum value shown in Table, “TIRE LOAD LIMITS AT VARIOUS COLD INFLATION PRESSURES” in TRA, or “INFLATION PRESSURE” in ETRTO, however, in the case that the tire is for a passenger car, it is set to 180 kPa. The normal load refers to a load specified for each tire by standards in a standard system including the standards according to which tires are provided, and is “a maximum load capacity” in JATMA, a maximum value described in the Table in TRA, or “LOAD CAPACITY” in ETRTO, however, in the case that the tire is for a passenger car, it is 85% of a corresponding load to 180 kPa of internal pressure.

In the embodiment, the mediate land line 22 (hereinafter merely referred to as “land line 22” in some cases) is formed as a rib extending continuously in the tire circumferential direction. The land line 22 is not provided with lateral grooves separating the land line 22 into blocks in the tire circumferential direction. The land line 22 is provided with a plurality of notches 32 formed at intervals in the tire circumferential direction. Each of the notches is a groove extending between one end portion open into the main groove and the other end closed in the land line. The land lines 20 other than the land line 22 are formed as block lines in which a plurality of blocks separated from each ether in the tire circumferential direction by lateral grooves 31, 33 to 35, respectively, are arranged. However, the respective land lines are not limited to the above-described configurations and may be ribs or block lines.

A tread profile TP is an imaginary plane passing through the closest edge among edges of the land lines 20 to the tire equatorial plane TE (hereinafter referred to as “closest edge”) and the opposite contact ends CE, CE and forming a single arc in the section along the tire meridian. In the embodiment, an edge 23E1 positioned on the left side in the figures among edges 23E1, 23E2 of the center land line 23 is the closest edge. If a height of the closest edge changes along the tire circumferential direction, a height at a position on the innermost side in the tire diametrical direction is employed. If the main grooves 10 are the zigzag grooves and the edges of the land lines 20 wind in the tire width direction, the closest edge is determined at a center of a width of the winding. If the edges of the land lines 20 have chamfered shapes, a point of intersection of an extended line of a top face of the land line 20 and an extended line of a groove wall face is regarded as the edge and the closest edge is determined. If there are two closest edges on left and right sides, one of the edges positioned on the inner side in the tire diametrical direction is employed.

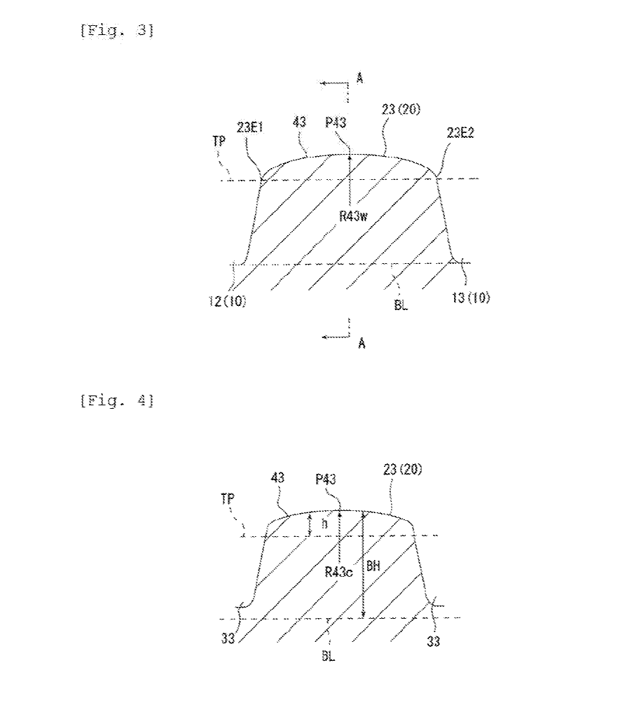

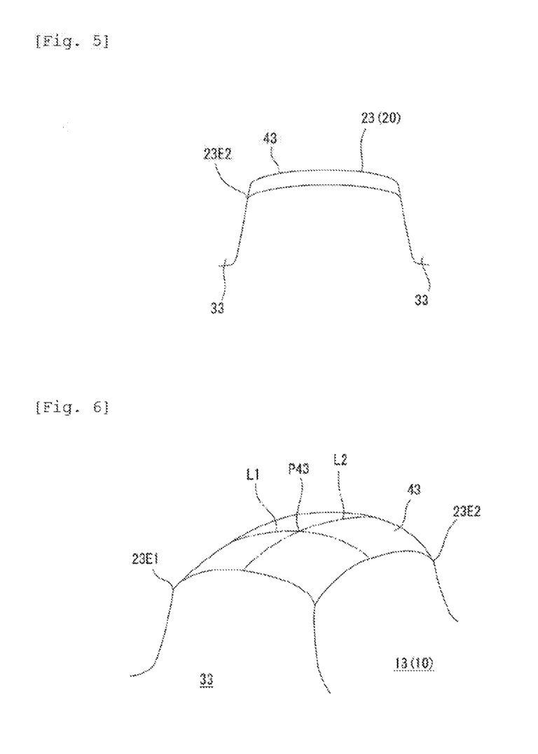

FIG. 3 shows a section along the tire meridian of the center land line 23 (hereinafter merely referred to as “land line 23” in some cases). FIG. 4 shows a section of the land line 23 parallel to the tire equatorial plane TE and corresponds to the section along line A-A in FIG. 3. As described above, the land line 23 is formed as the block line and the block line is formed by a plurality of blocks 43. FIG. 5 is a side view of the block 43 and FIG. 6 is a perspective view of the block 43. In FIGS. 4 and 5, a left-right direction corresponds to the tire circumferential direction. In FIG. 6, a center line L1 passing through a center of the block 43 in the tire circumferential direction and a center line L2 passing through a center of the block 43 in the tire width direction are shown.

In the embodiment, the land line 23 protrudes outward in the tire diametrical direction from the tread profile TP (see FIGS. 1 and 3). The plurality of lateral grooves 33 are formed at intervals in the tire circumferential direction in the land line 23 (see FIG. 2) and each of the blocks 43 formed between the lateral grooves 33 has a protruding height h from the tread profile TP that increases from circumferential opposite end portions toward a circumferential central portion of the block 43 (see FIG. 4). In this way, it is possible to help the circumferential central portions of the blocks 43 come in contact with the ground to thereby enhance the contact property of the land line 23. The enhancement of the land line 23 contributes to improvement of a contact property of the tread face 8, which increases irregular wear resistance and braking performance.

As shown in FIG. 4, the top face of each of the blocks 43 is formed in an arc shape protruding outward in the tire diametrical direction in the section parallel to the tire equatorial plane TE. In the section, the top face of the block 43 is in a shape along the arc having a center (not shown) on the inner side of the top face in the tire diametrical direction and a radius R43c of curvature of the arc is preferably 5000 mm or smaller in order to secure a contact pressure at the block 43. Furthermore, the radius R43c of curvature is preferably larger than 50 mm in order to prevent the contact pressure at the block 43 (especially at the circumferential central portion) from becoming excessively high.

As shown in FIG. 3, the top face of each of the blocks 43 is formed in an arc shape protruding outward in the tire diametrical direction in the section along the tire meridian. In the section, the top face of the block 43 is in a shape along the arc having a center (not shown) on the inner side of the top face in the tire diametrical direction and a radius R43w of curvature of the arc is preferably 5000 mm or smaller in order to secure the contact pressure at the block 43. Furthermore, the radius R43w of curvature is preferably larger than 50 mm in order to prevent the contact pressure at the block 43 (especially at the circumferential central portion) from becoming excessively high.

In the embodiment, a block height BH increases from the circumferential opposite end portions toward the circumferential central portion of each of the blocks 43 as shown in FIG. 4. The block height BH is a height of the block from a groove bottom line BL which is an arc-shaped imaginary line connecting groove bottoms of the main grooves 10. A peak P43 is a position where the top face of the block 43 has the largest protruding height h (and block height BH). In the embodiment, the peak P43 is provided at the center of the block 43 in the tire circumferential direction and the tire width direction. However, the position of the peak P43 is not limited to the center of the block 43 and the peak P43 may be provided at a position displaced from the center as described later.

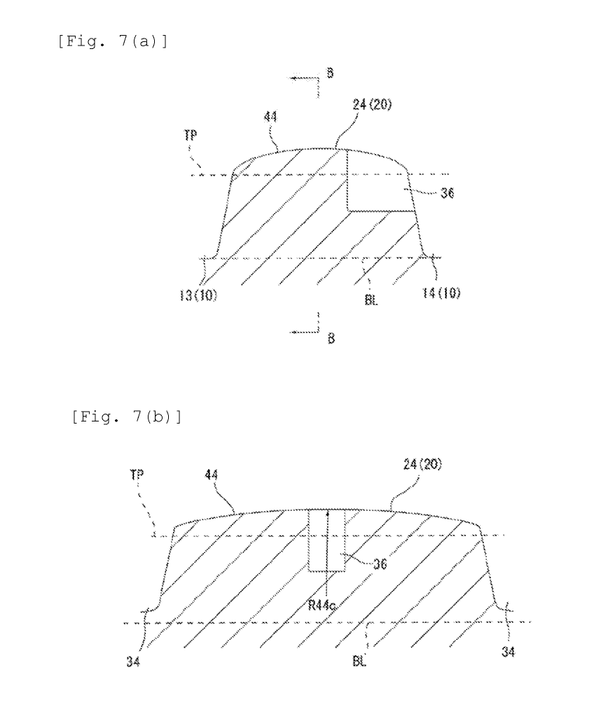

As shown in FIGS. 2 and 7(a) and 7(b), the mediate land line 24 (hereinafter merely referred to as “land line 24” in some cases) adjacent to the land line 23 is provided with lateral grooves 34 and notches 36. In the embodiment, the above-described configuration for enhancing the contact property is applied to the land line 24 as well. In other words, the land line 24 protrudes outward in the tire diametrical direction from the tread profile TP and the plurality of lateral grooves 34 are formed at intervals in the tire circumferential direction in the land line 24. Each of the blocks 44 formed between the lateral grooves 34 has a protruding height from the tread profile TP that increases from circumferential opposite end portions toward a circumferential central portion of the block 44.

As can be seen from FIG. 2, a length of each of the blocks 44 in the tire circumferential direction is larger than a length of each of the blocks 43 in the tire circumferential direction. The blocks 44 having the relatively large lengths in the tire circumferential direction and the blocks 43 having the relatively small lengths in the tire circumferential direction are provided in the different land lines. In the section parallel to the tire equatorial plane TE (see FIGS. 4 and 7(b)), a radius R44c of curvature of an arc forming a top face of each of the blocks 44 having the relatively large length in the tire circumferential direction is larger than the radius R43c of curvature of the arc forming the top face of each of the blocks 43 having the relatively small length in the tire circumferential direction. In this way, the top face of each of the blocks 43, 44 is formed in the arc shape having the curvature suitable for the length of the block in the tire circumferential direction, which enhances the contact property of each of the land lines 23, 24.

In the embodiment, the above-described configuration for enhancing the contact property is applied to each of the center land line 23 and the mediate land line 24. The land line(s) to which the configuration for enhancing the contact property is applied is preferably the center land line and/or the mediate land line.

Although the five land lines 20 respectively protrude outward in the tire diametrical direction from the tread profile TP in the example shown in the embodiment, the invention is not limited to this example. At least one of a plurality of land lines 20 needs to protrude outward in a tire diametrical direction from a tread profile TP and it suffices that the configuration for enhancing the contact property is applied to the land line protruding outward in the tire diametrical direction from the tread profile TP.

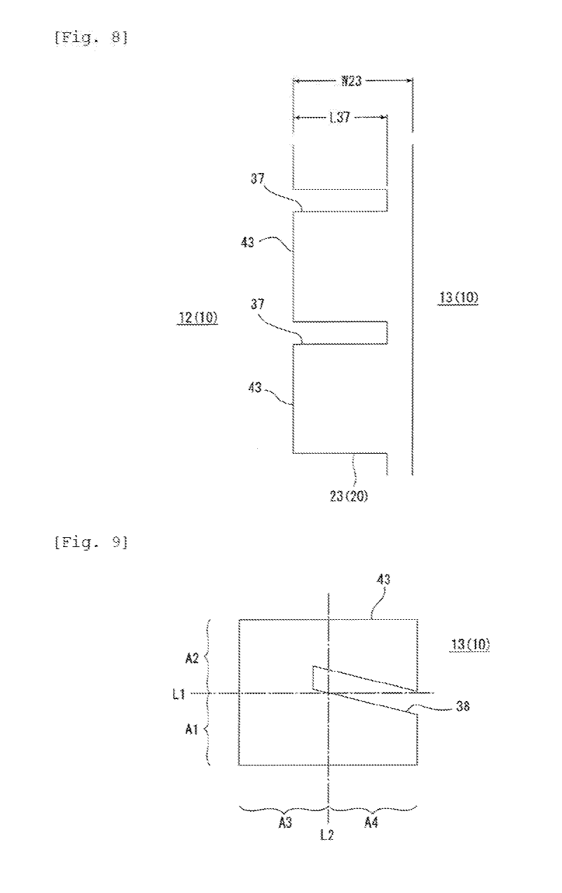

Because variations described by using FIGS. 8 to 11 have the same configurations as that of the above-described embodiment except configurations described below, the common configurations will not be described and differences will be mainly described. The configurations described in the above embodiment will be provided with the same reference signs and will not be described repeatedly. The plurality of variations described can be employed in combination without specific constraints.

In the variation in FIG. 8, a land line 23 is formed not as a block line including a plurality of completely separate blocks but as a rib. Note that a plurality of notches 37 are formed at intervals in a tire circumferential direction in the land line 23 and virtual blocks 43 adjacent to each other in the tire circumferential direction and connected to each other at portions in a tire width direction are formed between the respective notches 37. Although it is not shown in the figures, the top face shape shown in FIGS. 3 to 6 is applied to each of the blocks 43, which enhances a contact property of the land line 23. In forming the virtual blocks 43, it is preferable that a length L37 of each of the notches 37 in the tire width direction is larger than 50% of a width W23 of the land line 23.

In the variation shown in FIG. 9, a notch 38 is formed only on one side (a right side in FIG. 9) of each of blocks 43 in a width direction and a notch is not formed on an opposite side. Each of the blocks 43 has different void ratios between one side and the other side in a tire circumferential direction. To put it concretely, the void ratio V1 of a first area A1 positioned on one side (a lower side in FIG. 9) of a center of the block 43 in the tire circumferential direction is smaller than a void ratio V2 of a second area A2 positioned on the other side (an upper side in FIG. 9) (i.e., V1<V2). As shown in FIG. 10, a protruding height h1 of the first area A1 is larger than a protruding height h2 of the second area A2 of the block 43 (i.e., h1>h2).

A center line L1 is an imaginary line passing through the center of the block 43 in the tire circumferential direction and having a straight-line shape in a plan view. The center line L1 separates the block 43 into the first area A1 and the second area A2. The void ratio is obtained as a value x/(x+y) by dividing an opening area x of a groove in a top face of a land line by the sum of an area y of a contact portion of the top face of the land line and the opening area x of the groove. Therefore, the void ratio V1 of the block 43 is obtained by dividing an opening area of the notch 38 in the first area A1 by the sum of an area of a contact portion of the first area A1 and the opening area of the notch 38. The void ratio V2 and void ratios V3, V4 (described later) are obtained similarly. A void ratio difference (V2−V1) is 3 (%) or larger, for example.

In the block 43 in FIG. 9, the void ratio V1 of the first area Al is smaller than the void ratio V2 of the second area A2 as described above. Therefore, a stretch degree is relatively low in the first area A1, which may result in impairment of the contact property. However, the protruding height h1 of the first area A1 is larger than the protruding height h2 of the second area A2 in the block 43, which helps the first area A1 come in contact with the ground to enhance the contact property of the block 43 to thereby enhance the contact property of the land line 23. A peak P43 is provided at a position in the first area A1 and displaced from the center line L1.

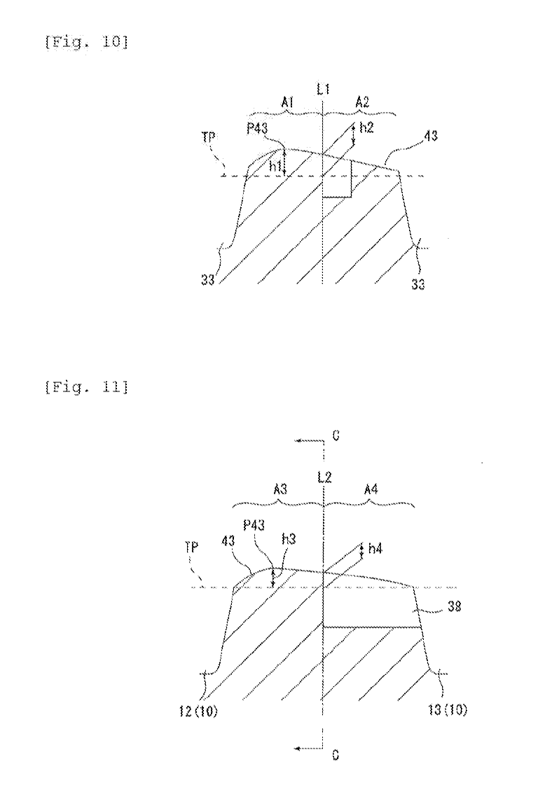

In the variation in FIG. 9, each of the blocks 43 has different void ratios between one side and the other side in a tire width direction. To put it concretely, the void ratio V3 of a third area A3 positioned on one side (a left side in FIG. 9) of a center of the block 43 in the tire width direction is smaller than the void ratio V4 of a fourth area A4 positioned on the other side (a right side in FIG. 9) (i.e., V3<V4). As shown in FIG. 11, a protruding height h3 of the third area A3 may be larger than a protruding height h4 of the fourth area A4 (i.e., h3>h4). A center line L2 is an imaginary line passing through the center of the block 43 in the tire width direction and having a straight-line shape in a plan view. The center line L2 separates the block 43 into the third area A3 and the fourth area A4. A void ratio difference (V4−V3) is 3 (%) or larger, for example.

In the block 43 in FIG. 9, the void ratio V3 of the third area A3 is smaller than the void ratio V4 of the fourth area A4 as described above. Therefore, a stretch degree is relatively low in the third area A3, which may result in impairment of the contact property. However, if the protruding height h3 of the third area A3 is larger than the protruding height h4 of the fourth area A4 as described above, it is possible to help the third area A3 come in contact with the ground to enhance the contact property of the block 43 to thereby enhance the contact property of the land line 23. A peak P43 is provided at a position in the third area A3 and displaced from the center line L2.

The pneumatic tire according to the invention can be formed in the same way as a normal pneumatic tire except that the tread face is formed in the above-described manner. Therefore, any of conventionally known materials, shapes, configurations, and manufacturing methods can be employed in the invention.

The present invention is not limited to the embodiment mentioned above, but can be improved and modified variously within the scope of the present invention.

What is claimed is:

1. A pneumatic tire comprising:
a tread face;
a plurality of main grooves extending in a tire circumferential direction in the tread face; and
a plurality of land lines defined by the plurality of main grooves in the tread face,
wherein at least one of the plurality of land lines extends outward in a tire diametrical direction from a tread profile,
a plurality of lateral grooves or notches are formed at intervals in the tire circumferential direction in the at least one land line, and
each of blocks formed between the lateral grooves or the notches has a protruding height from the tread profile that increases from circumferential opposite end portions toward a circumferential central portion of the block.

2. The pneumatic tire according to claim 1, wherein a top face of each of the blocks is formed in an arc shape protruding outward in the tire diametrical direction in a section parallel to a tire equatorial plane.

3. The pneumatic tire according to claim 2, wherein, in the section parallel to the tire equatorial plane, a radius of curvature of an arc forming a top face of each of the blocks having a relatively large length in the tire circumferential direction is larger than a radius of curvature of an arc forming a top face of each of the blocks having a relatively small length in the tire circumferential direction.

4. The pneumatic tire according to claim 1, wherein a top face of each of the blocks is formed in an arc shape protruding outward in the tire diametrical direction in a section along a tire meridian.

5. The pneumatic tire according to claim 2, wherein a top face of each of the blocks is formed in an arc shape protruding outward in the tire diametrical direction in a section along a tire meridian.

6. The pneumatic tire according to claim 1, wherein the blocks are formed in a center land line passing through the tire equatorial plane or a mediate land line positioned on an outer side of the center land line in a tire width direction.

7. The pneumatic tire according to claim 1, wherein a void ratio of a first area positioned on one side of a center of each of the blocks in the tire circumferential direction is smaller than a void ratio of a second area positioned on the other side and a protruding height of the first area is larger than a protruding height of the second area.

8. The pneumatic tire according to claim 1, wherein a void ratio of a third area positioned on one side of a center of each of the blocks in the tire width direction is smaller than a void ratio of a fourth area positioned on the other side and a protruding height of the third area is larger than a protruding height of the fourth area.
